(19) United States
(12) Patent Application Publication
(10) Pub. No.: US 2014/0151580 A1
(43) Pub. Date: Jun. 5, 2014

(54) METHODS OF USING POLISHED SILICON WAFER STRIPS FOR EUV HOMOGENIZER

(71) Applicant: KLA-Tencor Corporation, Milpitas, CA (US)

(72) Inventors: Daimian Wang, Fremont, CA (US); Frank Chilese, San Ramon, CA (US)

(73) Assignee: KLA-Tencor Corporation, Milpitas, CA (US)

(21) Appl. No.: 14/082,676

(22) Filed: Nov. 18, 2013

Related U.S. Application Data
(60) Provisional application No. 61/732,213, filed on Nov. 30, 2012.

(51) Int. Cl. G02B 27/09

(52) U.S. Cl. CPC G02B 27/0938
USPC 250/504 R; 29/592.1

(57) ABSTRACT

The present invention is a light homogenizer or light tunnel with highly reflective sides that enable the focusing of EUV illumination. The sides of the homogenizer are cut from a highly polished silicon wafer. The wafer is coated with a reflective coating before the strips are cut from the wafer. The invention also includes a method for flattening the strips and applying a backing to the strips enabling easier manipulation of the strips during assembly and use.

### CROSS REFERENCE TO RELATED APPLICATIONS

This patent application claims the benefit under 35 U.S.C. §119(e) of U.S. Provisional Application No. 61/732,213, filed Nov. 30, 2012, which application is incorporated herein by reference in its entirety.

### FIELD OF THE INVENTION

The field of the present invention is extreme ultraviolet light (EUV) reticle inspection systems, particularly regarding the uniformity of EUV light impinging on the target reticles, and more particularly on devices to improve the uniformity of EUV light impinging on the target reticles.

### BACKGROUND OF THE INVENTION

Optical homogenization is required to improve the illumination field uniformity and pupil stability for EUV reticle inspection systems. Directing EUV light through a long, narrow, reflective tunnel (“homogenizer”) is one method used to achieve the required light homogenization. A homogenizer tunnel is comprised of four pieces of long mirrors forming a rectangular tunnel with open ends and with or without a mechanical taper in the tunnel.

Because of the small dimensions of EUV light tunnels, it is difficult and expensive to manufacture the mirrors for the tunnel due to the high cost of polishing and coating large surfaces. In addition, in order to achieve a high degree of light homogenization, light must reflect off the sides of the light tunnel at a grazing angle of less than 2 degrees. This requires a high degree of flatness in the range of less than 1 μm. Depending on specific operational requirements, it may be necessary that the light tunnel include a mechanical taper to further narrow or expand the width and/or height of the EUV illumination as it emerges from the homogenizer.

Therefore, there is a need in the field for a less expensive method of assembling an EUV light homogenization tunnel having the required shape, length, and reflectivity on the interior surface to effectively direct EUV illumination onto a reticle during the reticle inspection process.

### SUMMARY OF THE INVENTION

The present invention broadly comprises a EUV light homogenizer for a EUV reticle inspection system comprising a hollow four sided tunnel. The four sided tunnel includes four strips with each of the four strips having an inner surface and an outer surface. Each of the inner surfaces is coated with a high reflectivity coating. The four strips are joined to form the four-sided tunnel with the four inner surfaces facing the interior of the light tunnel. In one embodiment, the light homogenizer is tapered.

The present invention also broadly comprises a method of assembling a light tunnel for a EUV illumination reticle inspection system the method comprising: polishing a silicon wafer; coating the silicon wafer with a high reflectivity coating; and cutting the silicon wafer into at least four strips. Each of the four strips has a first side and a second side with the high reflectivity coating applied onto the first side. Mounting substrate is applied to the second side of each of the at least four strips. Each of the strips is flattened against a flat surface; and, assembled to form the light tunnel such that each first side of the at least four strips forms the interior surface of the light tunnel. In one embodiment, each of the four strips is tapered to form a tapered light homogenizer when the at least four strips are joined to form the homogenizer.

One object of the invention is to present a EUV illumination homogenizer that is fabricated without individually polishing and coating the small components of the homogenizer.

A second object of the invention is to provide a method of fabricating a EUV illumination homogenizer that simplifies the polishing, coating, and assembly steps in fabricating the device.

A third object of the invention is to describe a EUV illumination homogenizer fabricated from easily available materials.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a schematic depiction of a silicon wafer in which at least four strips are cut or divided out from the body of the wafer;

FIG. 2 depicts the separate strips cut from a single wafer;

FIG. 2A shows tapered strips cut from a single wafer;

FIG. 3 demonstrates schematically a method used to flatten individual wafer strips;

FIG. 4 is an exploded end view showing the individual strips with backing in position to be assembled into the light homogenizer;

FIG. 5 is a side perspective view of the assembled light tunnel of the present invention also depicting purge gas passing through the light tunnel; and,

FIG. 6 is a side perspective view of the light tunnel schematically demonstrating the light reflective capability of the tunnel.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

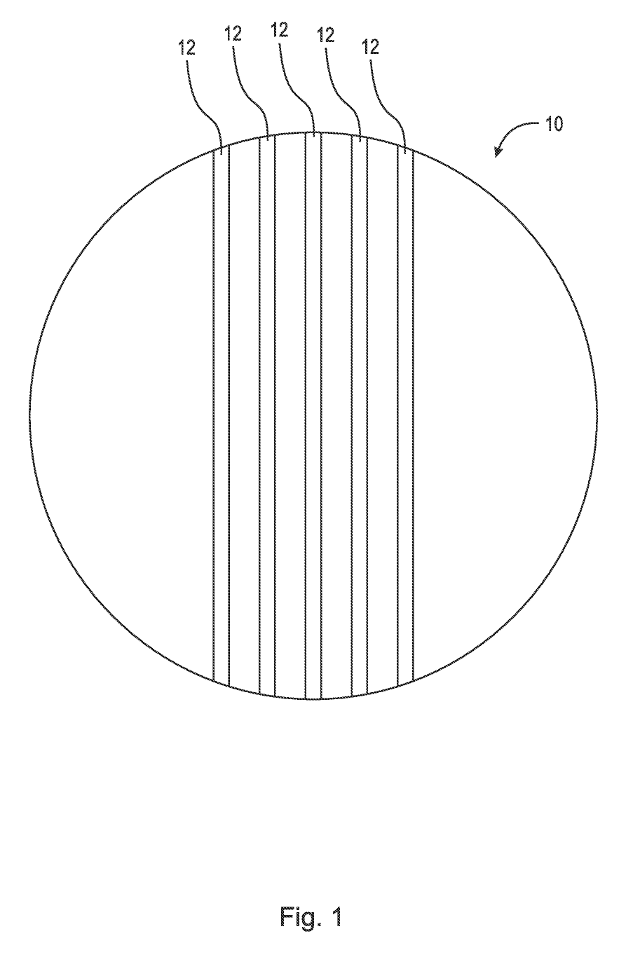

Adverting to the drawings, FIG. 1 is a schematic depiction of a wafer 10, e.g. a silicon wafer, in which at least four strips 12 are cut or divided out from the body of wafer 10. Before cutting strips 12, wafer 10 is polished in a known manner used with wafers 10 that may be used for other purposes. After polishing, wafer 10 is coated with a high reflectivity coating such as ruthenium. By high reflectivity is meant a coating suitable to achieve a high reflectivity for EUV light as a grazing incident angle of less than 2 degrees.

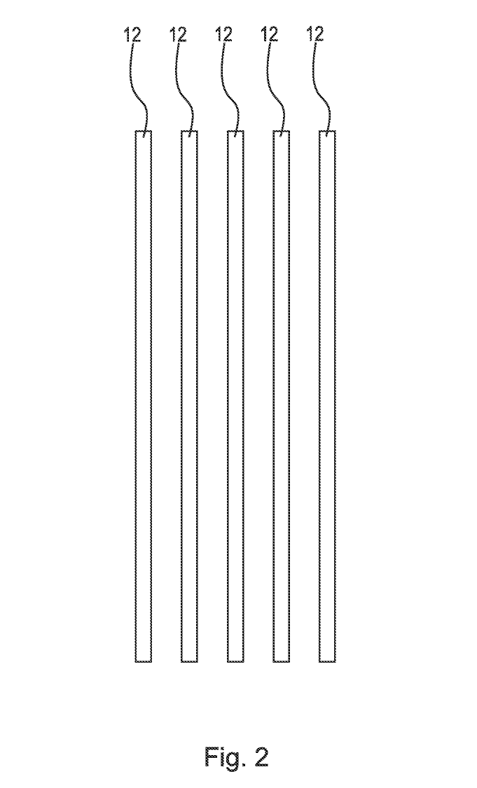

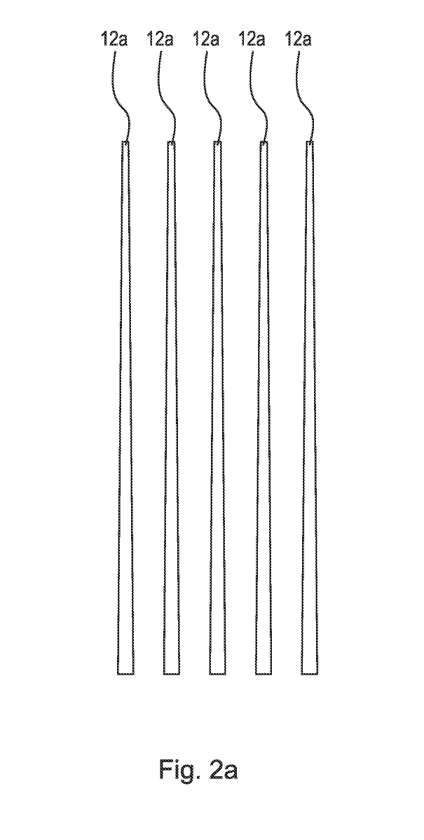

FIG. 2 depicts the separate strips 12 cut from wafer 10. The dimension of an individual strip 12 is determined by the dimensions of the homogenizer, or light tunnel, to be fabricated and the size of wafer 10. For example, with an industry standard 300 mm wafer 10, the strip 12 can be range from about approximately 100 to 280 mm in length. For an industry standard 450 mm wafer 10, strip 12 can range from about 280 to about 440 mm in length. Wafer 10 is cut along the high symmetric crystal orientation of wafer 10 so the formation of edge chip can be reduced. The width of each strip 12 can be 0.2-4 mm. Consequently, multiple strips 12 can be made from a single wafer 10. FIG. 2A depicts an alternate embodiment in which separate strips 12a cut from wafer 10 are tapered. Lengths longer than 440 mm up to about 800 mm can be achieved by attaching two homogenizers together length-wise (end-to-end) using epoxy adhesive and/or nut and bolt assemblies.

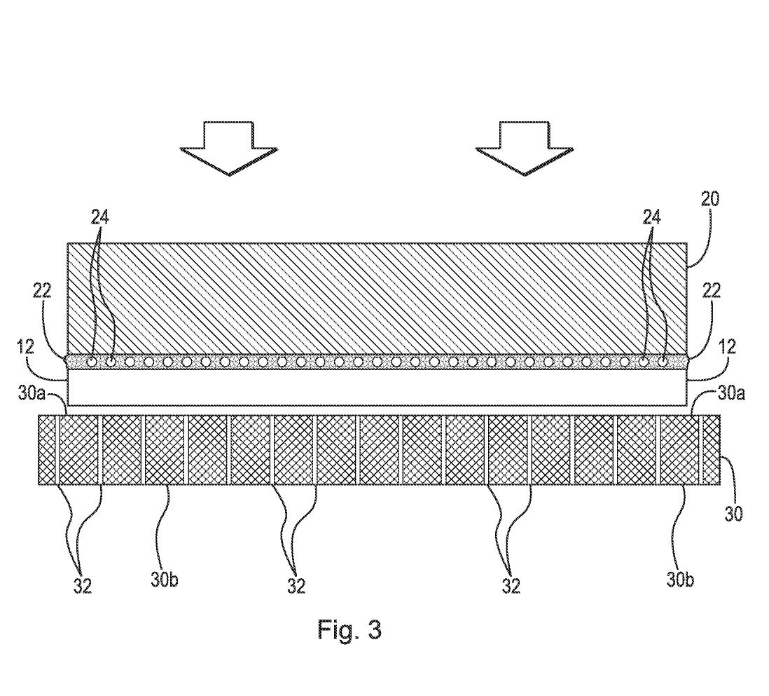

FIG. 3 demonstrates schematically a method used to flatten each strip 12. Strips 12 or 12a are placed on flat surface 30a (“surface 30a”) of block 30. Block 30 may be formed from granite or other dense material able to withstand heavy pressure. Surface 30a is highly polished to form a surface flatness of less than 1 μm. Pinholes 32 extend from surface 30a to the opposing surface 30b and enable strips 12 (or strips 12a) to be drawn flat against flat surface 30a by drawing a vacuum through pinholes 32 from opposing side 30b.

While strips 12 are being flattened, they are mounted on substrate or backing 20 by laying backing strips against individual strips 12. Pressing force, represented by the arrows, forces backing 20 onto strips 12 and it is fixedly attached to the strips using a layer 22 of epoxy adhesive. Backing 20 may be fabricated from ceramic or metal. In one embodiment, spacers 24 of equal size are interspersed in the epoxy layer 22 to produce an even gap between strip 12 and backing 20 as spacers 24 will maintain an even gap throughout the area of strip 12 as pressure is applied to backing 20. In one embodiment, spacers 24 are glass beads. In one embodiment, the gap is 0.0005 inches.

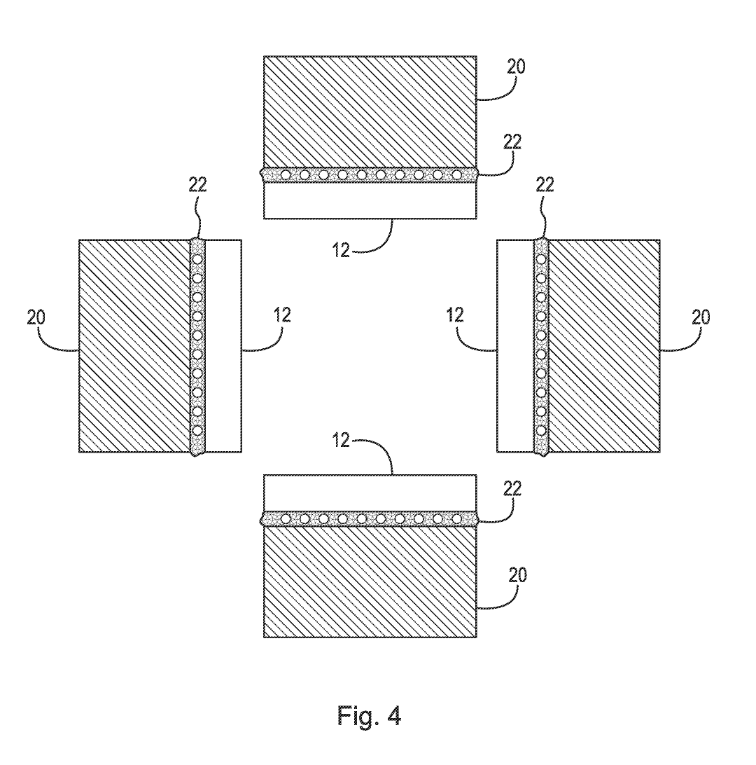

FIG. 4 is an exploded end view of homogenizer 50. Strips 12 with backing 20 are in position to be assembled into homogenizer 50. The epoxy layer 22 and spacers 24 are seen between strip 12 and backing 20. Additional epoxy and/or appropriate nut and bolt assemblies may be used to assemble strips 12 to form the constructed light homogenizer or light tunnel 50 in a known manner. An assembled homogenizer 50 will have a substantially rectangular shape with square ends. By substantially in this context is meant that homogenizer 50 appears visually to be a rectangular shaped tunnel with similarly sized heights and widths and a length greater than the heights and widths. A tapered homogenizer (not shown) would include similar sized widths and heights that would narrow or expand along the length of the tapered homogenizer.

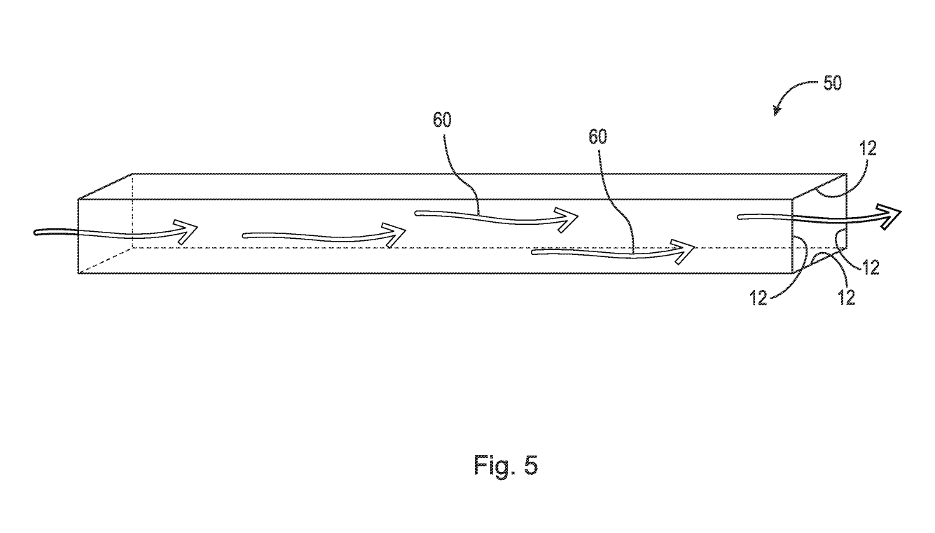

FIG. 5 is a side perspective view of the assembled light tunnel 50 with backing 20 and epoxy layer 22 removed for clarity. Arrows 60 represent purge gas passing through light tunnel 50 to capture or entrain gases produced by the epoxy adhesive. By entrain is meant to draw in and transport (as solid particles or gas) by the flow of a fluid. In this case, the fluid is a gas such as hydrogen or helium. In a preferred embodiment, the epoxy adhesive will be a low outgassing producer.

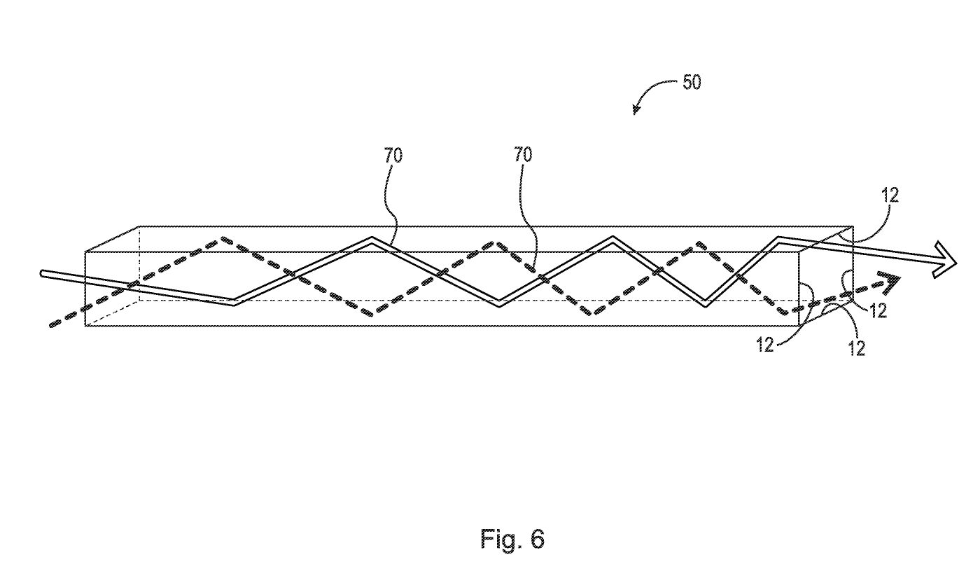

FIG. 6 is a side perspective view of assembled light homogenizer 50 with the arrows depicting the light 70 reflective capability of homogenizer 50. The reflective coating and flat inner surface of the strips 12 created with the vacuum method discussed above endows homogenizer 50 with a reflectivity that can be greater than 98 percent. Consequently, after multiple reflections, the total reflectivity loss can be limited to less than 10 percent. Therefore, homogenizer 50 of the present invention not only acts to focus EUV light onto the inspection optics it also reduces loss of EUV light so that a greater amount of EUV light illuminates the reticle inspection optics. It should be recognized that purging, as described above, may tale place while EUV illumination is passed through homogenizer 50.

Thus it is seen that the objects of the invention are efficiently obtained, although changes and modifications to the invention should be readily apparent to those having ordinary skill in the art, which changes would not depart from the spirit and scope of the invention as claimed.

What is claimed is:

1. A EUV light homogenizer for a EUV reticle inspection system comprising:
a hollow four sided tunnel, wherein said four sided tunnel include four flat strips, each of said four flat strips having an inner surface and an outer surface;
wherein each of said inner surfaces is coated with a high reflectivity coating; and, wherein said four strips are joined to form said four-sided tunnel.

2. The EUV light homogenizer as recited in claim 1 further comprising a mounting substrate applied to said outer surface.

3. The EUV light homogenizer as recited in claim 2 wherein said mounting substrate is a ceramic material.

4. The EUV light homogenizer as recited in claim 2 wherein said mounting substrate is metal.

5. The EUV light homogenizer as recited in claim 1 wherein said high reflectivity coating is ruthenium.

6. The EUV light homogenizer as recited in claim 1 wherein said four strips are joined to form said four-sided tunnel using an epoxy, said epoxy having a low outgassing rate.

7. The EUV light homogenizer as recited in claim 1 wherein said four-sided tunnel ranges in length from about 100 mm to about 800 mm.

8. The EUV light homogenizer as recited in claim 7 wherein said EUV light homogenizer comprises two attached EUV light homogenizers, wherein said two attached EUV light homogenizers are attached lengthwise end-to-end.

9. The EUV light homogenizer as recited in claim 1 wherein each of said four strips ranges in width from about 0.2 mm to about 4 mm.

10. The EUV light homogenizer as recited in claim 1 wherein said four-sided tunnel is substantially rectangular in shape.

11. The EUV light homogenizer as recited in claim 1 wherein purge gas is passed through said EUV light homogenizer.

12. The EUV light homogenizer as recited in claim 11 wherein said purge gas is hydrogen.

13. The EUV light homogenizer as recited in claim 11 wherein said purge gas is helium.

14. A method of assembling a light tunnel for a EUV illumination reticle inspection system comprising:
polishing a silicon wafer;
coating said silicon wafer with a high reflectivity coating;
cutting said silicon wafer into at least four strips, each of said at least four strips having a first side and a second side, wherein said high reflectivity coating is on said first side;
applying mounting substrate to said second side of each of said at least four strips;
flattening each of said at least four strips against a flat surface; and,
assembling said at least four strips to form said light tunnel;
wherein each first side of said at least four strips forms a single interior surface of said light tunnel.

15. The method of assembling a light tunnel for a EUV illumination reticle inspection as recited in claim 14 wherein said substrate mounting is ceramic.

16. The method of assembling a light tunnel for a EUV illumination reticle inspection as recited in claim 14 wherein said substrate mounting is metal.

17. The method of assembling a light tunnel for a EUV illumination reticle inspection as recited in claim 14 wherein flat surface defines a plurality of holes extending from a top of said flat surface through a bottom of said flat surface and wherein each of said at least four strips is flattened against said flat surface by a vacuum.

18. The method of assembling a light tunnel for a EUV illumination reticle inspection as recited in claim 14 further comprising pressing each of said at least four strips against said flat surface.

19. The method of assembling a light tunnel for a EUV illumination reticle inspection as recited in claim 14 further comprising the step of directing a purge gas through said tunnel.

20. The method of assembling a light tunnel for a EUV illumination reticle inspection as recited in claim 19 wherein said purge gas is hydrogen.

21. The method of assembling a light tunnel for a EUV illumination reticle inspection as recited in claim 19 wherein said purge gas is helium.

22. The method of assembling a light tunnel for a EUV illumination reticle inspection as recited in claim 14 wherein said assembly of said at least four strips is performed using epoxy.

23. The method of assembling a light tunnel for a EUV illumination reticle inspection as recited in claim 14 wherein said assembly of said at least four strips is performed using nut and bolt assemblies.

24. The method of assembling a light tunnel for a EUV illumination reticle inspection as recited in claim 14 wherein said high reflectivity coating is ruthenium.

25. The method of assembling a light tunnel for a EUV illumination reticle inspection as recited in claim 14 further comprising the step of attaching two assembled light tunnels lengthwise end-to-end.
